(19) United States
(12) Patent Application Publication
(10) Pub. No.: US 2016/0160895 A1
(43) Pub. Date: Jun. 9, 2016

(54) RELEASABLE TENON-PIN FOR CONSTRUCTION JOINTS

(71) Applicant: John Baldus, Montrose, CO (US)

(72) Inventor: John Baldus, Montrose, CO (US)

(21) Appl. No.: 14/930,447

(22) Filed: Nov. 2, 2015

Related U.S. Application Data
(60) Provisional application No. 62/059,107, filed on Nov. 3, 2014.
(60) Provisional application No. 62/079,509, filed on Nov. 13, 2014.

(51) Int. Cl. F16B 5/02; F16B 3/00

(52) U.S. Cl. CPC F16B 5/02; F16B 3/00

(57) ABSTRACT

An improved connecting device for rapid assembly or dis-assembly, without tools, of two or more structural elements to be joined together, where the end of one element abuts the side of another element. The joining device comprises a shaft that is attached to, or formed adjacent to, the end of one element, said shaft being inserted into and passed through a transverse bore in a second element. The resulting joint is then tightened and locked in place by either a nut threaded onto the projecting end of said shaft on the outside of said second element, or by a key inserted into a transverse bore in the projecting end of said shaft on the outside of said second element. The joint can quickly be dis-assembled by removing said nut or key.

### CROSS-REFERENCE TO PENDING PRIOR PATENT APPLICATIONS

This application claims benefit of pending prior Provisional Patent Applications: Ser. No. 62/059,107, filed 2014 Nov. 3; Ser. No. 62/079,509, filed 2014 Nov. 13; both by the present inventor, which patent applications are hereby incorporated herein by reference.

### DESCRIPTION

An improved connecting device for joining two or more structural elements, such as in furniture or other constructions, comprising a shaft fastened or formed adjacent to the end of one construction element, projecting beyond the end of said element. Said projecting end to be of sufficient length to pass through, and project beyond, a second construction element which is bored to accept said shaft. Said projecting end of said shaft to be threaded or bored to receive a locking device. In the case of said shaft being threaded, a nut of various types can be threaded onto the end of said shaft, on the outside of said second element, holding the joint together. In the case of said shaft being bored, a pin or key of various types can be inserted in said bore, on the outside of said second element, holding the joint together. Removing either said nut or said pin allows dis-assembly of the joint.

### TECHNICAL FIELD

The present invention pertains to construction joints between two or more structural elements, such as in furniture, temporary displays, scaffolding, or other constructions where the end of one element joins to the side of another element, particularly when it is desirable for the joint to be quickly assembled or dis-assembled without tools, such as in knock-down furniture or other temporary constructions.

### BACKGROUND ART

A huge variety of connecting devices are known in the prior art for joining structural elements, such as legs and frame of an article of furniture. Frequently these devices consist of two or more parts which are fastened to the structural elements, with various means of connecting the parts together. Often some means is provided for tightening the joint after assembly. Relevant to this discourse are patents listed in the citation list below.

### SUMMARY OF THE INVENTION

### Technical Problems

Connecting devices known in the art for joining structural elements are frequently complex in design, resulting in higher costs for manufacturing and installation. For most of the known devices, machining and alignment for installing must be accurate and precise, requiring advanced tooling and skills not available to consumers. In the case of elements provided un-assembled, to be assembled by the consumer, such as in what is known as knock-down furniture, assembly is often complicated and requires tools to accomplish. The construction is frequently structurally weak, especially if used with weaker materials such as particleboard, because of dependence on fasteners that are put under stresses beyond their holding ability. This means that with time and use, these connecting devices, and the elements they are fastened to, break or disintegrate. Dis-assembly for re-use is often difficult or impossible.

### Solution to Problems

Accordingly, it is a principal object of this invention to overcome these disadvantages by combining simple application; simple, strong, and inexpensive parts; strong joinery; easy assembly and dis-assembly without need of tools; and re-usability.

It is a further object of this invention to accomplish these aims by use of a novel and improved design that is elementary and uncomplicated in both manufacture and use.

It is a further object of this invention to provide an inexpensive joining device that is less costly to manufacture and use to make such joints.

It is a further object of this invention to provide a joining device that is easy for consumers to install with limited skills and basic tools.

It is a further object of this invention to provide a construction that can be quickly assembled or disassembled without tools, comprising a knock-down type of construction.

It is a further object of this invention to provide a joining device that is easily removed for re-use on another construction.

### ADVANTAGES OF PRESENT INVENTION

Accordingly, several advantages of one or more embodiments of the present invention are as follows:

The device is elementary in design, reducing cost of manufacture and complexity of installation.

The simplicity of the device allows installation and use by anyone with simple tools and basic skills.

Tolerances for proper installation are loose, so precision is not required to achieve satisfactory performance.

The process of installation is simple and quick, requiring only two fasteners and one bore for each unit, reducing time, frustration, and costs.

The method of passing the shaft through the element to be joined, rather than inserting or fastening into said element, means that the joint has much greater structural strength, even if used with weaker materials.

The ease and speed of assembly and dis-assembly, and the lack of need for tools to knock down the construction, allows use by anyone, even children or persons with disabilities.

The device can easily be removed and re-used for another construction, resulting in long life of use, with consequent savings in time and resources.

Other advantages of one or more aspects of the present invention may be apparent from consideration of the drawings and ensuing description.

### DRAWINGS

### Reference Numerals

101, 201, 301—shaft of tenon-pin
102. 202, 302—locking device, nut or pin
306—tapered bore for lock-pin
103, 205, 303—vertical element of construction
104, 204, 304—horizontal element of construction
105, 207, 308—screw fasteners for tenon-pin
107, 206, 307—bore through vertical element
106, 305—knee-brace
203—stiffening plate
208—screw fastener for 203

### BRIEF DESCRIPTION OF DRAWINGS

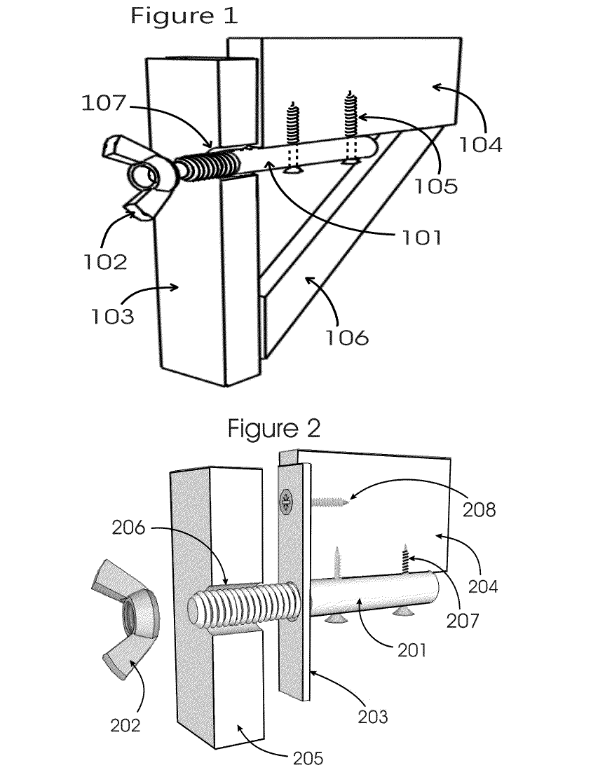

FIG. 1 is an isometric view with cutaway showing one embodiment of the present invention as it would look when assembled.

FIG. 2 is an isometric view with cutaway showing the same embodiment of the present invention, with a different stiffening brace.

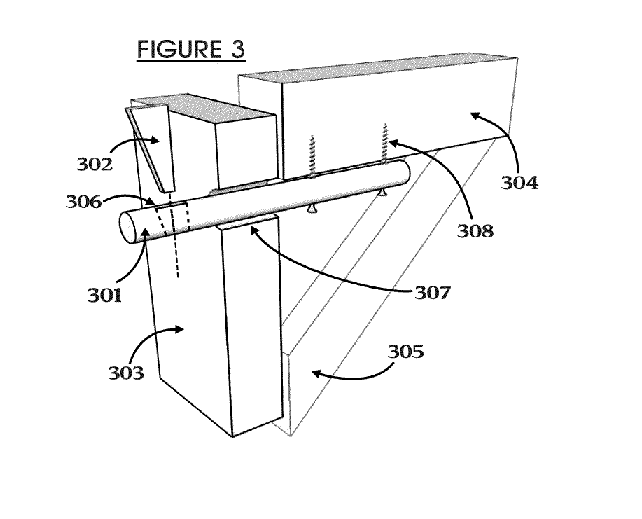

FIG. 3 is an isometric view with cutaway showing a variant embodiment of the present invention.

### DETAILED DESCRIPTION OF EMBODIMENTS

FIG. 1: One embodiment of the device shown here consists of a cylindrical shaft of metal or other suitably strong material (101), being threaded on one end to accept a nut, in this drawing being a wing-nut (102). Various other types of nut known in the art could be used in this embodiment, such as hex-nut, knobs of various forms, square nut, bored and threaded plate, custom-designed knob, or other. The construction elements to be joined are shown partially cut away, as items (103 and 104). The vertical element (103) shows the penetrating bore (107). In this embodiment, a knee-brace (106) provides reinforcement to the assembled construction, but other means known in the art can be used, such as gusset brace, angle iron, or other. The fasteners shown in this embodiment are screws (105), inserted through bores in the shaft, but various other fastening methods known in the art can be used, depending on need and type of materials used for the construction, such as bolts, nails, welding, adhesives, forming the shaft as an integral part of the construction element, or other.

FIG. 2 shows the same embodiment and fastening method, but shows another option for bracing, being a stiff plate of metal (203) or other suitably strong material, fastened by a screw (208) to the end of the horizontal construction element (204). This plate can be replaced by other bracing methods known in the art, as discussed above. The shaft (201) is shown fastened to the horizontal element by screws (207), and passing through the bore (206) in the vertical element (205) to be locked in place by the nut (202).

FIG. 3 shows a variant embodiment using a cylindrical shaft of metal or other suitably strong material as the tenon-pin (301), but instead of threading, uses a tapered bore or slot (306) through the shaft. To mate with this slot, the locking device in this embodiment is a tapered or wedge shaped key (302). It should be noted that the cylindrical form of the shaft is optional in this embodiment, other shapes may be utilized. The construction elements are again shown partially cut away (303, 304) with a bore (307) through the vertical element. Screw fasteners are shown here (308), but again, various fastening methods known in the art can be used. In this drawing, a knee-brace is used (305), being one of several methods known in the art for stiffening the construction, as discussed above.

### Operation

The tenon-pin shaft (101, 201, 301) is fastened to one element of the construction by various means. It is then passed through the bore in the second element. Then the locking device, (102, 202, or 302), is threaded onto or passed through the tenon-pin and tightened as much as the construction requires. To dis-assemble, remove the nut or pin, and pull the joint apart.

### CITATION LIST

### Patent Literature

| Cited Patent | Pub. date | Applicant | Title |
|---|---|---|---|
| U.S. Pat. No. 3,271,056 | 1966 SEP. 6 | FRISBEY, JR | FASTENING DEVICE |
| U.S. Pat. No. 3,118,543 A | 1964 JAN. 21 | DRESDNER | IND. JOINT FURNITR. KIT |
| U.S. Pat. No. 2,866,239 A | 1958 DEC. 30 | LAMBERT | MORT. AND TENON JOINT |
| US 20100232872 A1 | 2010 SEP. 16 | KATO | TENON ROD AND T. JOINT |
| EP 2208895 A3 | 2012 MAY 23 | GAUDIER | MORT. [symbol] TENON W/PIN |
| DE 3619571 A1 | 1987 DEC. 17 | DRABSCH | PIN-TYPE CONNECTION |
| US D261340 S | 1981 OCT. 20 | CLYBURN | FURN. LEG [symbol] RAIL CONN. |
| U.S. Pat. No. 4,372,224A | 1983 FEB. 8 | EHRLICH | KNOCK-DOWN FURN. CONS. |
| U.S. Pat. No. 3,835,610A | 1974 SEP. 17 | HARPER | JOINT FOR STRUC. MEM.S |
| U.S. Pat. No. 4,325,649 A | 1982 APR. 20 | ROCK | JOINING DEVICE-FURNIT. |
| U.S. Pat. No. 6,863,464 B1 | 2005 MAR. 8 | NIKLAUS | DETACHBL. ASSY. 2 ELEMTS |

25. What is claimed is an improved device for connecting construction elements, comprising a shaft fastened or formed adjacent to the end of a first element, said shaft then being passed through a transverse bore in a second element, joining the elements together.

26. The method of claim 0025, wherein the joint is tightened and locked together after assembly by a nut being threaded onto the end of the said shaft.

27. Or, in a variant embodiment, the method of claim 0025, wherein the joint is tightened and locked together after assembly by a key inserted through a bore in said shaft on the outside of said second element.
